(19) United States
(12) Patent Application Publication
(10) Pub. No.: US 2017/0076675 A1
(43) Pub. Date: Mar. 16, 2017

(54) IMAGE DISPLAY DEVICE

(71) Applicant: JVC KENWOOD Corporation, Yokohama-shi (JP)

(72) Inventor: Masao HATANAKA, Yokohama-shi (JP)

(21) Appl. No.: 15/361,890

(22) Filed: Nov. 28, 2016

Related U.S. Application Data
(63) Continuation of application No. PCT/JP2015/051691, filed on Jan. 22, 2015.

(30) Foreign Application Priority Data
May 30, 2014 (JP) 2014-111957

(51) Int. Cl. G09G 3/34; G06T 7/40; G06T 1/60; G06T 7/00; G09G 3/36

(52) U.S. Cl. CPC G09G 3/3406; G06T 7/0081; G09G 3/3648; G06T 1/60; G06T 7/408; G09G 2360/145; G09G 2310/08; G09G 2320/0626; G02F 1/13318

(57) ABSTRACT

First and second display drivers drive a display unit to display a first image based on a first image data in a first display region of the display unit, and a second image based on a second image data in a second display region. First and second luminance sensors detect a brightness of an image on the first and second display region, respectively. First luminance adjuster adjusts the luminance of the first image, such that the brightness of an image on the first display region that is to be detected by the first luminance sensor becomes a first sensor luminance value. Second luminance adjuster adjusts the luminance of the second image, such that the brightness of an image on the second display region that is to be detected by the second luminance sensor becomes a second sensor luminance value.

### CROSS REFERENCE TO RELATED APPLICATION

This application is a Continuation of PCT Application No. PCT/JP2015/051691, filed on Jan. 22, 2015, and claims the priority of Japanese Patent Application No. 2014-111957, filed on May 30, 2014, the entire contents of both of which are incorporated herein by reference.

### BACKGROUND

The present disclosure relates to an image display device that is capable of dividing a display region of a display unit into plurality, and displaying images in respective divided display regions. In recent years, screens of image display devices for displaying medical images (hereafter, a medical image display device) are widening. In conjunction with this, it becomes possible to divide one screen (the display region) into plurality and display a plurality of images in parallel.

In addition, for a medical image display device, there is a need to strictly manage display qualities of images to be displayed. In Japan, it is required that the display quality of the medical image display device is managed according to JESRA X-0093 (QA Guideline).

For this reason, as described in Japanese Patent Application Publication No. 2007-193355 (Patent Document 1), it is common for a medical image display device to have a luminance sensor for detecting the brightness of an image on the screen, and control the luminance of an image to be displaced based on the brightness detected by the luminance sensor.

### SUMMARY

In the case where a plurality of images are displayed in parallel on the image display device, the respective display quality of a plurality of images cannot be managed in high precision by the conventional display quality management method as described in Patent Document 1. For this reason, there is a desire for an image display device that is capable of managing the respective display quality of a plurality of images in high precision, even in the case where a plurality of images are displayed in parallel on the image display device.

An aspect of the embodiments provides an image display device, including: a display unit; a first display driver configured to drive the display unit to display a first image based on first image data in a first display region of the display unit; a second display driver configured to drive the display unit to display a second image based on second image data in a second display region of the display unit; a first luminance sensor configured to detect a brightness of an image on the first display region, when the first display driver displays the first image in the first display region; a second luminance sensor configured to detect a brightness of an image on the second display region, when the second display driver displays the second image in the second display region; a first luminance adjuster configured to adjust a luminance of the first image to be displayed in the first display region, such that a brightness of an image on the first display region that is to be detected by the first luminance sensor becomes a first sensor luminance value; and a second luminance adjuster configured to adjust a luminance of the second image to be displayed in the second display region, such that a brightness of an image on the second display region that is to be detected by the second luminance sensor becomes a second sensor luminance value.

### BRIEF DESCRIPTION OF THE DRAWINGS

FIG. 1 is a block diagram showing an image display device according to at least one embodiment.

FIG. 2 is a partial block diagram showing another example of an image data generation device for supplying two sets of image data to the image display device according to the embodiment.

FIG. 3 is a partial block diagram showing an example of an image data generation device for supplying one set of image data to the image display device according to the embodiment .

FIG. 4 is a plan view for explaining an example of a concrete shape of the display unit 20 and an attachment position of a luminance sensor.

FIG. 5 is a block diagram for explaining the calibration of a luminance sensor.

FIG. 6 is a characteristic diagram showing an input/output characteristic of a look-up table.

FIG. 7 is a diagram conceptually showing image quality adjustment data stored in a non-volatile memory.

### DETAILED DESCRIPTION

In the following, an image display device according the embodiment will be described with references to the accompanying drawings. The image display device according the present embodiment is a medical image display device by way of example, but it is not limited to being a medical image display device.

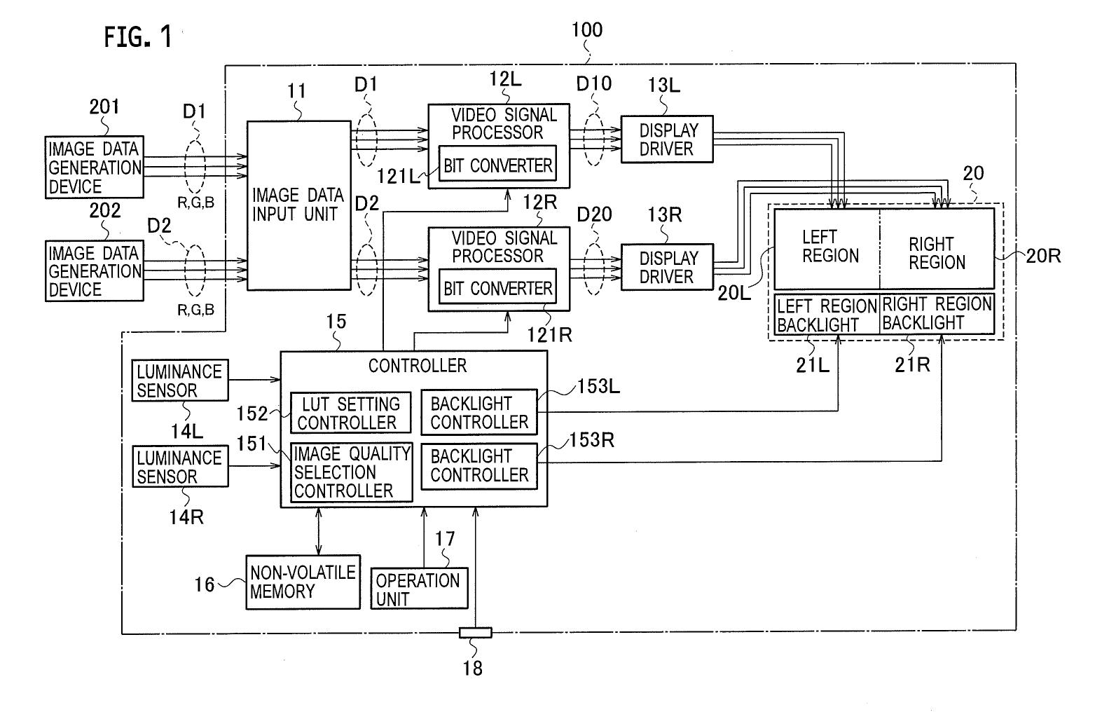

In FIG. 1, the two image data generation devices 201 and 202 are connected to the image display device 100, for example. The image data generation devices 201 and 202 output image data showing various types of images such as X-ray images, vivo imaging images, etc., to be used for diagnosis at a medical practice site. The image data generation devices 201 and 202 can be configured by personal computers.

The image data generation device 201 outputs image data D1, and the image data generation device 202 outputs image data D2. The image data D1 and D2 are input into the image data input unit 11. The image data D1 and D2 respectively include three primary color video signals of R (red), G (green), and B (blue). The image data D1 and D2 are 8-bit digital data, for example.

The image data input unit 11 supplies the image data D1 to the video signal processor 12L, and the image data D2 to the video signal processor 12R. The image data input unit 11 may supply the image data D1 to the video signal processor 12R, and the image data D2 to the video signal processor 12L. The image data input unit 11 can be configured by an input/output circuit for the image data. The video signal processors 12L and 12R can be configured by video signal processing circuits.

The image data input unit 11 may have a function for switching between a state of supplying the image data D1 to the video signal processor 12L and supplying the image data D2 to the video signal processor 12R, and a state of supplying the image data D1 to the video signal processor 12R and supplying the image data D2 to the video signal processor 12L.

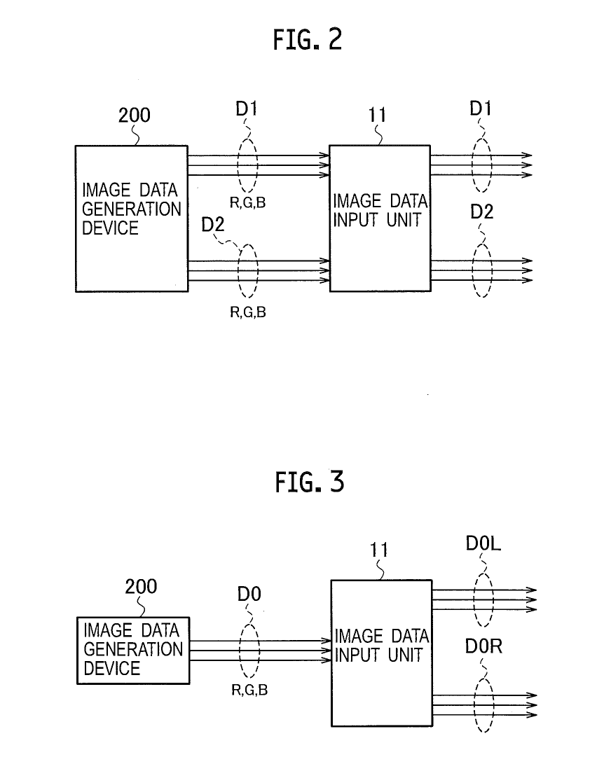

In FIG. 1, the sources of generation of the image data D1 and D2 are the separate image data generation devices 201 and 202, but as shown in FIG. 2, one image data generation device 200 may generate both of the image data D1 and D2. The image data generation device 200 can be configured by a personal computer.

It is supposed that the image data D1 is image data to be displayed in the left region 20L of the screen on the display unit 20, and the image data D2 is image data to be displayed in the right region 20R of the screen on the display unit 20.

As shown in FIG. 3, there may be a case where the image data generation device 200 outputs the image data D0 to be displayed in an entire display region (screen) on the display unit 20. In this case, the image data input unit 11 supplies image data D0L of a portion corresponding to the left region 20L to the video signal processor 12L, and image data D0R of a portion corresponding to the right region 20R to the video signal processor 12R, among the image data D0.

In FIG. 1, there may be a case where the image data generation device 201 supplies the image data D0 to the image data input unit 11, and where the image data generation device 202 supplies the image data D0 to the image data input unit 11.

The video signal processors 12L and 12R respectively have bit converters 121L and 121R. The video signal processors 12L and 12R convert 8 bits into 16 bits by the bit converters 121L and 121R in order to signal process the image data D1 and D2 in high precision, for example. Although it is preferable to execute the signal processing with an increased number of bits, it is also possible to execute the signal processing without increasing the number of bits.

The bit converters 121L and 121R convert the image data D1 and D2 of 8 bits to the image data D1 and D2 of 16 bits, using look-up tables (LUT) to be described below.

The video signal processors 12L and 12R can set the color temperature and the gamma characteristics for the image data D1 and D2 at the time of converting the image data D1 and D2 in R, G, and B into the image data D1 and D2 of 16 bits by the bit converters 121L and 121R. The video signal processors 12L and 12R function as image quality setting units for setting the color temperature and the gamma characteristics for images to be displayed on the display unit 20.

The video signal processors 12L and 12R may apply signal processing called a uniformity correction with respect to the image data D1 and D2, in order to correct luminance irregularity and color irregularity.

The display unit 20 is supposed to be a liquid crystal panel capable of displaying 10-bit image data, by way of example. The video signal processors 12L and 12R convert the image data D1 and D2 of 16 bits respectively to image data of 10 bits.

It is supposed that the image data of 10 bits output from the video signal processors 12L and 12R is the image data D10 and D20. The image data D10 and D20 are respectively supplied to the display drivers 13L and 13R. The display drivers 13L and 13R can be configured by display driving circuits.

The video signal processors 12L and 12R should preferably apply error diffusion processing for diffusing lower 6 bits onto upper 10 bits among the image data D1 and D2 in 16 bits. In this way, even though the image data D10 and D20 that are supplied to the display drivers 13L and 13R are in 10 bits, they become image data having a resolution corresponding to 16 bits.

The signal processing method in which the number of bits of the image data D1 and D2 is reduced, but an effective resolution of the image data D10 and D20 is set to be greater than or equal to the number of bits possessed by the image data D10 and D20, is not to be limited to the error diffusion processing. In the case where the bit converters 121L and 121R convert the image data D1 and D2 from 8 bits to 10 bits, processing such as error diffusion processing and the like will be unnecessary.

The display driver 13L drives the display unit 20 to display the image data D10 in the left region 20L of the display unit 20. The display driver 13R drives the display unit 20 to display the image data D20 in the right region 20R of the display unit 20. The display drivers 13L and 13R may be configured as a single display driver.

The left region 20L and the right region 20R of the display unit 20 may be equally divided half regions in the display region of the display unit 20, or may be unequally divided regions. In FIG. 1, an example is shown where the left region 20L and the right region 20R are equally divided.

Note that the left region 20L and the right region 20R are set up by dividing the display region virtually into two, as indicated by a double dotted chain line. Namely, the left half of the total number of pixels in the horizontal direction of the display region is allocated to the left region 20L, and the right half is allocated to the right region 20R. There is no need for the left region 20L and the right region 20R to be divided physically.

The left region backlight 21L is provided with respect to the left region 20L, and the right region backlight 21R is provided with respect to the right region 20R. As will be described later, the left region backlight 21L and the right region backlight 21R are physically divided.

The left region backlight 21L and the right region backlight 21R may be a rear-type backlight to be arranged on the rear side of the display unit 20, or may be an edge-lighting type backlight to be arranged on the side-facing end portions of the display unit 20.

In FIG. 1, the left region backlight 21L and the right region backlight 21R are shown at lower portions of the left region 20L and the right region 20R, for convenience. The concrete positions of the left region backlight 21L and the right region backlight 21R will be described later.

To the display unit 20, the luminance sensors 14L and 14R are attached in order to detect how bright the images based on the image data D10 and D20, that are to be displayed in the left region 20L and the right region 20R, are actually displayed on respective screens of the left region 20L and the right region 20R. In FIG. 1, the luminance sensors 14L and 14R are shown to be separate from the display unit 20, for convenience.

Brightness detection values detected by the luminance sensors 14L and 14R are input into the controller 15. The controller 15 can be configured by a microprocessor or a microcomputer. To the controller 15, a non-volatile memory 16, an operation unit 17, and an external input terminal 18 are connected. The non-volatile memory 16 is one example of a storage unit, and can be configured by an EEPROM (Electrically Erasable and Programmable Read-Only Memory), for example.

The operation unit 17 maybe provided on a casing (a bezel 20bz to be described below) of the image display device 100, or may be a remote controller. The external input terminal 18 is a USB (Universal Serial Bus) input terminal, for example. The external input terminal 18 may be an input terminal that is not in accordance with the USB standard.

The controller 15 has an image quality selection controller 151, a LUT setting controller 152, and backlight controllers 153L and 153R as its functional internal configuration. The image quality selection controller 151, the LUT setting controller 152, and each of the backlight controllers 153L and 153R may be configured by respective circuits. The operation of the image quality selection controller 151 and the LUT setting controller 152 will be described later.

The backlight controller 153L controls the luminance in the left region 20L by controlling the amount of light of the left region backlight 21L. The backlight controller 153R controls the luminance in the right region 20R by controlling the amount of light of the right region backlight 21R.

The left region backlight 21L and the backlight controller 153L function as the luminance adjuster for adjusting the luminance of the image to be displayed in the left region 20L. The right region backlight 21R and the backlight controller 153R function as the luminance adjuster for adjusting the luminance of the image to be displayed in the right region 20R.

In the present embodiment, the display unit 20 is configured with a liquid crystal panel, so that the left region backlight 21L and the backlight controller 153L, as well as the right region backlight 21R and the backlight controller 153R, are functioning as the luminance adjusters.

If the display unit 20 is a display device of the other scheme such as the cathode ray tube or the organic electroluminescence panel and the like, it suffices to provide a luminance adjuster suitable for the respective scheme.

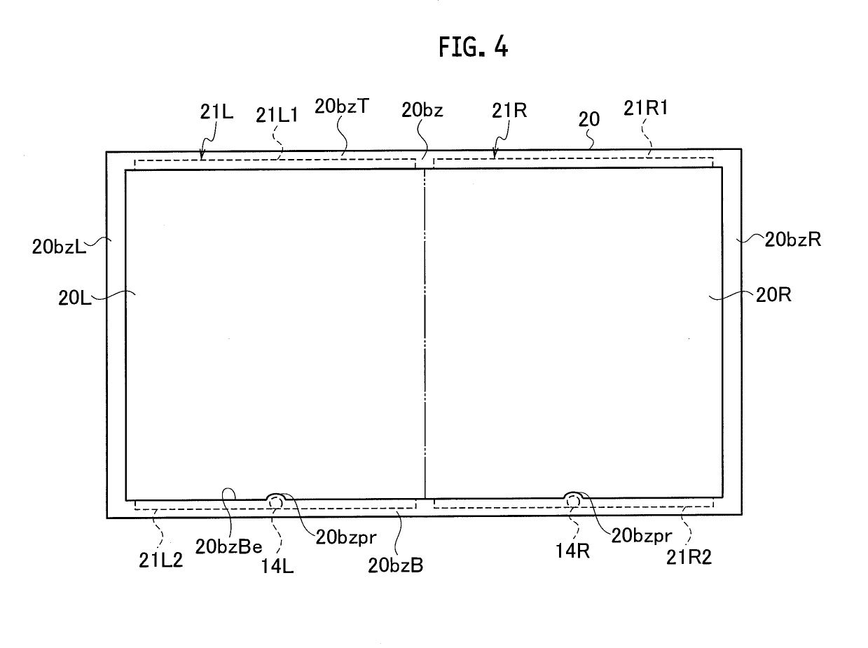

An example of the attachment positions of the luminance sensors 14L and 14R in the display unit 20 will be described by using FIG. 4. As shown in FIG. 4, an outer circumferential portion of the display unit 20 is enclosed by a bezel 20bz formed by a plastic resin. The bezel 20bz is formed integrally, and has respective portions of a top frame 20bzT, a bottom frame 20bzB, a left frame 20bzL, and a right frame 20bzR.

In the present embodiment, the left region backlight 21L and the right region backlight 21R are backlights of the edge lighting type.

The left region backlight 21L includes the upper side backlight 21L1 arranged inside the top frame 20bzT, and the lower side backlight 21L2 arranged inside the bottom frame 20bzB. The right region backlight 21R includes the upper side backlight 21R1 arranged inside the top frame 20bzT, and the lower side backlight 21R2 arranged inside the bottom frame 20bzB.

As shown in FIG. 4, the left region backlight 21L and the right region backlight 21R are physically divided, and the left region backlight 21L and the right region backlight 21R are controlled independently.

The left region backlight 21L may be configured with either one of the upper side backlight 21L1 and the lower side backlight 21L2 alone, and the right region backlight 21R may be configured with either one of the upper side backlight 21R1 and the lower side backlight 21R2 alone.

The left region backlight 21L and the right region backlight 21R are configured suitably with light emission diodes (LED). The left region backlight 21L and the right region backlight 21R may be configured with cold cathode fluorescent Tubes (CCFL) .

On the bottom frame 20bzB, the protruded portions 20bzpr that are protruding upwards in approximately arcuate shapes from the end portion 20bzBe on the screen side of the bottom frame 20bzB are formed at centers in a horizontal direction of the left region 20L and the right region 20R respectively. The luminance sensors 14L and 14R are arranged inside the bottom frame 20bzB, to be concealed by the protruded portions 20bzpr on the left and right.

The luminance sensors 14L and 14R detect the brightness of images at the lower end portions of the left region 20L and the right region 20R respectively, in a state in which images based on the image data D10 and D20 are being displayed. The luminance sensors 14L and 14R are arranged at the lower end portion of the screen, so that they won't be obstacles when a user watches the displayed images. On the lower end portion of the screen, a sensor area in which the luminance sensors 14L and 14R detect the brightness of images may be provided.

Incidentally, the position where the luminance sensors 14L and 14R are arranged is not limited to the lower end portion of the screen. The luminance sensors 14L and 14R may be arranged at any end portion where the luminance sensors 14L and 14R won't be obstacles when a user watches the displayed images.

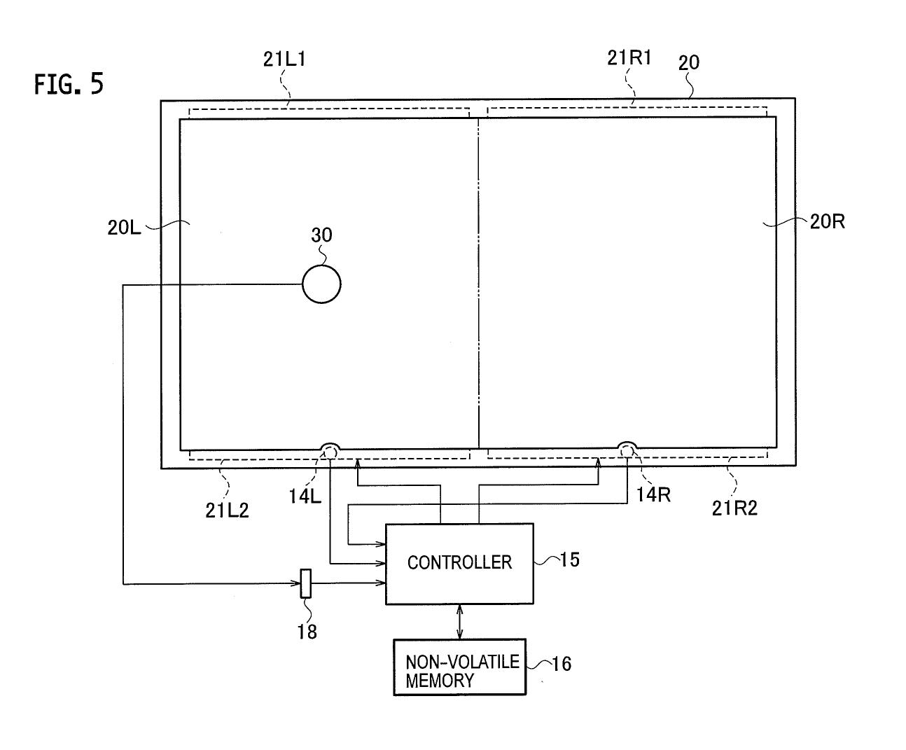

Here, the significance of providing the luminance sensors 14L and 14R will be described by using FIG. 5. In order to strictly manage the luminance as a display quality of the image to be displayed on the display unit 20, it suffices to detect how bright the image actually is being displayed on the screen. At this point, it is desirable to detect the brightness of the image at a central portion of the screen.

In the case where the display unit 20 is divided into the left region 20L and the right region 20R, it is desirable to detect both the brightness of the image at the central portion of the left region 20L, and the brightness of the image at the central portion of the right region 20R.

However, in the ordinary state of use of the image display device 100, if the luminance sensors 14L and 14R were arranged at respective central portions of the left region 20L and the right region 20R, they would be obstacles when a user looks at the displayed images. Consequently, it is not possible to detect the brightness of the image by arranging the luminance sensors 14L and 14R at the central portions.

For this reason, it suffices to obtain in advance a correlation between the brightness of the images at the respective central portions of the left region 20L and the right region 20R and the brightness of the images at the lower end portions that are to be detected by the luminance sensors 14L and 14R, and to detect the brightness of the images at the lower end portions with the luminance sensors 14L and 14R.

The image display device 100 is configured to estimate the brightness of the images at the central portions according to the correlation obtained in advance, based on the brightness detected by the luminance sensors 14L and 14R.

In FIG. 5, calibration software is executed by the image data generation device 201 or 202 (or 200) described by FIG. 1 to FIG. 3, and a calibration image is displayed on the display unit 20.

As shown in FIG. 5, the external sensor 30, connected to the external input terminal 18, is arranged at a central portion of the left region 20L. The luminance of the calibration image is controlled to be a prescribed luminance by the controller 15 (the backlight controller 153L).

Suppose that the prescribed luminance is 400 cd/m², for example. A detection value of the external sensor 30 via the external input terminal 18 and a detection value of the luminance sensor 14L are input into the controller 15. The controller 15 acquires the detection value of the luminance sensor 14L as a sensor luminance value when the external sensor 30 is detecting the brightness of the image to be 400 cd/m². The sensor luminance value detected by the luminance sensor 14L will be a first sensor luminance value.

Suppose that the sensor luminance value of the luminance sensor 14L is 390 cd/m² when the external sensor 30 is detecting the brightness of the image to be 400 cd/m², for example. Then, when the controller 15 controls the left region backlight 21L such that the sensor luminance value of the luminance sensor 14L becomes 390 cd/m², the brightness of 400 cd/m² will be obtained at the central portion of the left region 20L.

The brightness of the image to be displayed at the central portion of the left region 20L is set to be a display luminance value. The controller 15 stores the acquired sensor luminance value corresponding to the display luminance value into the non-volatile memory 16.

Similarly, in the right region 20R, an external sensor 30 is arranged at a central portion of the right region 20R, and when the external sensor 30 is detecting the brightness of the image to be 400 cd/m², the controller 15 acquires the detection value of the luminance sensor 14R at that time as the sensor luminance value. The sensor luminance value detected by the luminance sensor 14R will be a second sensor luminance value.

The controller 15 stores the acquired first and second sensor luminance values corresponding to the display luminance values into the non-volatile memory 16.

When the external sensor 30 detects the brightness of the image to be 400 cd/m² in the right region 20R, the sensor luminance value of the luminance sensor 14R is not necessarily the same as 390 cd/m² that is the sensor luminance value in the left region 20L. By way of example, there are cases where the sensor luminance value of the luminance sensor 14R becomes 385 cd/m^{2,} which is different from 390 cd/m² that is the sensor luminance value of the luminance sensor 14L.

As such, in order to display the images of the prescribed display luminance value respectively in the left region 20L and the right region 20R, it suffices to control the left region backlight 21L and the right region backlight 21R such that the sensor luminance values of the luminance sensors 14L and 14R become the sensor luminance value corresponding to the display luminance value.

There are cases where the relationship between the display luminance value at the respective central portions of the left region 20L and the right region 20R and the sensor luminance values of the luminance sensors 14L and 14R varies due to the change in time. For this reason, the calibration for taking a correlation between the display luminance value and the sensor luminance value should be carried out regularly, once per year, for example.

The display luminance value of the image to be displayed on the display unit 20 should preferably be switched among a plurality of images. To this end, in the present embodiment, the display luminance value is made to be selectable among three display luminance values, for example, using the operation unit 17.

When the display luminance values of the images to be displayed on the display unit 20 are different, the image quality should preferably be set in correspondence to the respective display luminance value. To this end, in the present embodiment, the controller 15 is configured to control the image quality of the image in correspondence to the respective display luminance value of the image to be displayed on the display unit 20. The controller 15 controls the image quality by adjusting the color temperature and the gamma characteristics of the image.

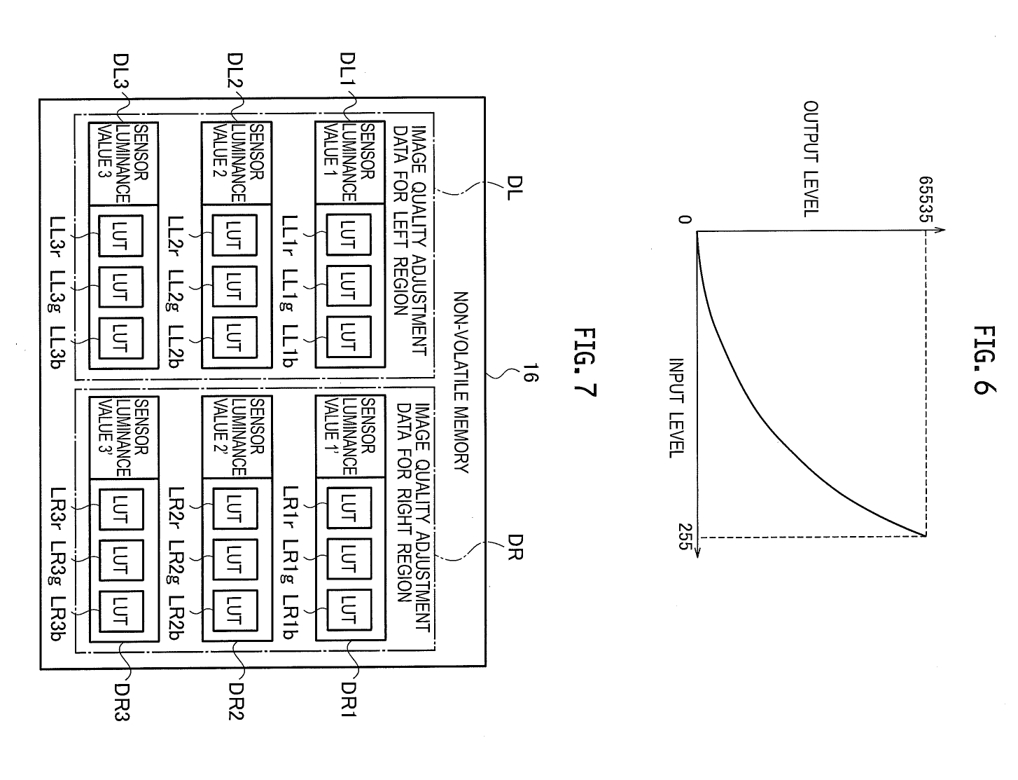

FIG. 6 conceptually shows look-up tables to be used in the bit converters 121L and 121R. The look-up tables exhibit an input/output characteristic for determining what kind of 16-bit output data the input data of 8-bit image data D1 and D2 should be converted to. Using this input/output characteristic, the color temperature and the gamma characteristics are adjusted when the images based on the image data D1 and D2 are displayed on the display unit 20.

The bit converters 121L and 121R convert the 8-bit image data D1 and D2 into the 16-bit image data D1 and D2 by using the look-up tables shown in FIG. 6.

The gamma characteristics indicated by the look-up tables should preferably be the gamma characteristics corresponding to DICON GSDF, or the gamma characteristics called Gamma 2.2.

The non-volatile memory 16 stores the look-up tables to be used in the bit converters 121L and 121R.

The image data D1 and D2 include R, G, and B video signals, so that the look-up tables corresponding to R, G, and B respectively are necessary. In correspondence to the three display luminance values, three look-up tables for R, G, and B are necessary. In correspondence to the image data D1 to be displayed in the left region 20L and the image data D2 to be displayed in the right region 20R, the look-up tables are necessary.

Consequently, in the present embodiment in which three of the image quality characteristics are selectable, comprising a set of the display luminance value, the color temperature, and the gamma characteristics, the non-volatile memory 16 stores 18 look-up tables.

FIG. 7 conceptually shows image quality adjustment data that is necessary in order to select the image quality characteristic stored in the non-volatile memory 16. The non-volatile memory 16 stores the image quality adjustment data DL for the left region and the image quality adjustment data DR for the right region.

In the present embodiment, as the display luminance values, it is supposed that 400 cd/m², 500 cd/m², and 800 cd/m² are selectable. These are examples of display luminance values.

In the left region 20L, the sensor luminance values for realizing the display luminance values of 400 cd/m², 500 cd/m², and 800 cd/m² are set to be the sensor luminance values 1, 2, and 3, respectively.

In the right region 20R, the sensor luminance values for realizing the display luminance values of 400 cd/m², 500 cd/m², and 800 cd/m² are set to be the sensor luminance values 1′, 2′, and 3′, respectively.

As mentioned before, even when it is attempted to make the left region 20L and the right region 20R to have the same display luminance value, there are cases where the sensor luminance value in the left region 20L and the sensor luminance value in the right region 20R are different. Consequently, the look-up tables should preferably be set in correspondence to the sensor luminance values for the left region 20L and the sensor luminance values for the right region 20R respectively.

The image quality adjustment data DL for the left region has an image quality adjustment data DL1 corresponding to the display luminance value of 400 cd/m², an image quality adjustment data DL2 corresponding to the display luminance value of 500 cd/m², and an image quality adjustment data DL3 corresponding to the display luminance value of 800 cd/m².

The image quality adjustment data DL1 includes the sensor luminance value 1, and a set of look-up tables LL1r, LL1g, and LL1b for R, G, and B to determine the color temperature and the gamma characteristics in correspondence to the sensor luminance value 1. The image quality adjustment data DL2 comprises the sensor luminance value 2, and a set of look-up tables LL2r, LL2g, and LL2b for R, G, and B to determine the color temperature and the gamma characteristics in correspondence to the sensor luminance value 2.

The image quality adjustment data DL3 includes the sensor luminance value 3, and a set of look-up tables LL3r, LL3g, and LL3b for R, G, and B to determine the color temperature and the gamma characteristics in correspondence to the sensor luminance value 3.

The image quality adjustment data DR for the right region have an image quality adjustment data DR1 corresponding to the display luminance value of 400 cd/m², an image quality adjustment data DR2 corresponding to the display luminance value of 500 cd/m², and an image quality adjustment data DR3 corresponding to the display luminance value of 800 cd/m².

The image quality adjustment data DR1 includes the sensor luminance value 1′, and a set of look-up tables LR1r, LR1g, and LR1b for R, G, and B to determine the color temperature and the gamma characteristics in correspondence to the sensor luminance value 1′. The image quality adjustment data DR2 includes the sensor luminance value 2′, and a set of look-up tables LR2r, LR2g, and LR2b for R, G, and B to determine the color temperature and the gamma characteristics corresponding to the sensor luminance value 2′.

The image quality adjustment data DR3 includes the sensor luminance value 3′, and a set of look-up tables LR3r, LR3g, and LR3b for R, G, and B to determine the color temperature and the gamma characteristics corresponding to the sensor luminance value 3′.

The look-up tables in the image quality adjustment data DL1 and DR1, the image quality adjustment data DL2 and DR2, and the image quality adjustment data DL3 and DR3 may all have the gamma characteristics corresponding to DICOM GSDF, or a part of them may have the gamma characteristics of Gamma 2.2.

The user can select the display luminance value of the image to be displayed on the display unit 20 from 400 cd/m², 500 cd/m², and 800 cd/m² by operating the operation unit 17.

When the display luminance value is selected, the image quality selection controller 151 reads out from the non-volatile memory 16 the image quality adjustment data corresponding to the selected display luminance value from the image quality adjustment data DL for the left region, and the image quality adjustment data DR for the right region.

Here, the case where 400 cd/m² is selected will be explained as an example. The image quality selection controller 151 reads out the image quality adjustment data DL1 and DR1 from the non-volatile memory 16. The controller 15 holds the sensor luminance values 1 and 1′.

The look-up table setting controller 152 (LUT setting controller) sets the look-up tables to the video signal processors 12L and 12R among the image quality adjustment data DL1 and DR1 read out from the non-volatile memory 16.

More specifically, the look-up table setting controller 152 sets the look-up tables LL1r, LL1g, and LL1b in the image quality adjustment data DL1 to the video signal processor 12L. The look-up table setting controller 152 sets the look-up tables LR1r, LR1g, and LR1b in the image quality adjustment data DR1 to the video signal processor 12R.

The bit converters 121L and 121R convert the 8-bit image data D1 and D2 into 16 bits using the respectively set look-up tables. The video signal processors 12L and 12R output the 16-bit image data D1 and D2 as the 10-bit image data D10 and D20.

As in the above, the controller 15 controls the image qualities of the first and second images respectively, such that the first image to be displayed in the left region 20L has the first color temperature and the first gamma characteristics, and the second image to be displayed in the right region 20R has the second color temperature and the second gamma characteristics.

The video signal processors 12L and 12R process the image data D1 and D2 to set the color temperature and the gamma characteristics of the images to be displayed in the left region 20L and the right regions 20R respectively, by converting the image data D1 and D2 using the set look-up tables.

More specifically, the video signal processor 12L processes the image data D1 such that the first image has the first color temperature and the first gamma characteristics, using the first set of look-up tables to determine the input/output characteristics of the R, G, and B video signals respectively in the image data D1.

The video signal processor 12R processes the image data D2 such that the second image has the second color temperature and the second gamma characteristics, using the second set of look-up tables to determine the input/output characteristics of the R, G, and B video signals respectively in the image data D2.

The backlight controller 153L controls the left region backlight 21L such that the sensor luminance value to be detected by the luminance sensor 14L becomes the sensor luminance value for the left region that is read out and held from the non-volatile memory 16.

The backlight controller 153R controls the right region backlight 21R such that the sensor luminance value to be detected by the luminance sensor 14R becomes the sensor luminance value for the right region that is read out and held from the non-volatile memory 16.

More specifically, in the case where 400 cd/m² is selected, the backlight controller 153L controls the left region backlight 21L such that the sensor luminance value to be detected by the luminance sensor 14L becomes the sensor luminance value 1. Also, the backlight controller 153R controls the right region backlight 21R such that the sensor luminance value to be detected by the luminance sensor 14R becomes the sensor luminance value 1′.

In this way, the backlight controllers 153L and 153R control the left region backlight 21L and the right region backlight 21R respectively such that the sensor luminance values to be detected by the luminance sensors 14L and 14R become the sensor luminance values that are read out and held from the non-volatile memory 16.

By this, the display luminance values in the respective central portions of the left region 20L and the right region 20R will be controlled to become the display luminance value selected by the user.

In the present embodiment described in the above, the image display device 100 is made to be capable of selecting three display luminance values, but it may be configured to display the images only with one display luminance value. The image display device 100 may be configured to be capable of selecting two, four, or more display luminance values.

As shown in FIG. 3, in the case where the image data generation device 200 supplies the image data D0 to be displayed on the entire screen in the display unit 20 to the image data input unit 11, it suffices to make it as follows.

The controller 15 respectively controls the image based on the image data D0L to be displayed in the left region 20L, and the image based on the image data D0R to be displayed in the right region 20R, similarly as in the case of displaying the images based on the image data D1 and D2.

In the present embodiment as described above, it is presupposed that the image display device 100 is to be used in a state where the display unit 20 is laterally long, so that expressions using left and right are used, such as the left region 20L and the right region 20R, the left region backlight 21L and the right region backlight 21R.

There may be cases where the image display device 100 is to be used in a state where the display unit 20 is vertically long. In this case, one of the left region 20L and the right region 20R will be an upper region, and the other one will be a lower region.

It suffices for the display unit 20 to have a first display region and a second display region. It suffices for the image display device 100 to be equipped with a first luminance sensor for detecting the brightness of the image on the first display region, and a second luminance sensor for detecting the brightness of the image on the second display region.

It suffices for the image display device 100 to be equipped with a first luminance adjuster for adjusting the luminance of a first image to be displayed in the first display region, and a second luminance adjuster for adjusting the luminance of a second image to be displayed in the second display region.

The display unit 20 may have three or more display regions. In this case, it suffices for the display unit 20 to be equipped with the luminance sensors in correspondence with the respective display regions.

As in the above, according to the image display device of the present embodiment, it is possible to manage the display qualities of the images to be displayed respectively in the plurality of display regions on the display unit, in high precision.

The present invention is not to be limited to the present embodiment described in the above, and can be variously modified in a scope not digressing from the essence of the present invention. A part of each unit constituting the image display device 100 may be configured by software (a computer program), and the appropriate use of hardware and software is arbitrary. Each unit constituting the image display device 100 may be configured by one or a plurality of integrated circuits.

What is claimed is:

1. An image display device, comprising:
a display unit;
a first display driver configured to drive the display unit to display a first image based on first image data in a first display region of the display unit;
a second display driver configured to drive the display unit to display a second image based on second image data in a second display region of the display unit;
a first luminance sensor configured to detect a brightness of an image on the first display region, when the first display driver displays the first image in the first display region;
a second luminance sensor configured to detect a brightness of an image on the second display region, when the second display driver displays the second image in the second display region;
a first luminance adjuster configured to adjust a luminance of the first image to be displayed in the first display region, such that a brightness of an image on the first display region that is to be detected by the first luminance sensor becomes a first sensor luminance value; and
a second luminance adjuster configured to adjust a luminance of the second image to be displayed in the second display region, such that a brightness of an image on the second display region that is to be detected by the second luminance sensor becomes a second sensor luminance value.

2. The image display device according to claim 1, further comprising a controller configured to control image qualities of the first and second images respectively, such that the first image to be displayed in the first display region has a first color temperature and a first gamma characteristic, and the second image to be displayed in the second display region has a second color temperature and a second gamma characteristic.

3. The image display device according to claim 2, wherein the first and second image data comprise R, G, and B video signals, and the image display device further comprises:
a first video signal processor configured to process the first image data such that the first image has the first color temperature and the first gamma characteristic, using a first set of look-up tables for determining respective input/output characteristics of R, G, and B video signals of the first image data, based on control by the controller; and
a second video signal processor configured to process the second image data such that the second image has the second color temperature and the second gamma characteristic, using a second set of look-up tables for determining respective input/output characteristics of R, G, and B video signals of the second image data, based on control by the controller.

4. The image display device according to claim 3, wherein
the first and second image data respectively have a first number of bits,
the first video signal processor includes a first bit converter configured to convert a number of bits of the first image data to a second number of bits that is greater than the first number of bits, using the first set of look-up tables, and
the second video signal processor includes a second bit converter configured to convert a number of bits of the second image data to the second number of bits, using the second set of look-up tables.

5. The image display device according to claim 1, wherein the display unit is a liquid crystal panel, and the image display device further comprises:
a first backlight provided corresponding to the first display region;
a second backlight provided corresponding to the second display region;
a first backlight controller configured to control an amount of light of the first backlight; and
a second backlight controller configured to control an amount of light of the second backlight;
wherein the first luminance adjuster includes the first backlight and the first backlight controller, and
the second luminance adjuster includes the second backlight and the second backlight controller.

6. The image display device according to claim 1, wherein the first and second luminance sensors are arranged at ends of the first and second display regions respectively.
